(19) United States
(12) Patent Application Publication
(10) Pub. No.: US 2023/0296318 A1
(43) Pub. Date: Sep. 21, 2023

(54) DRYER FOR DRYING VENEER PANELS

(71) Applicant: GRENZEBACH BSH GmbH, Bad Hersfeld (DE)

(72) Inventor: Christoph STRAETMANS, Schenklengsfeld (DE)

(73) Assignee: GRENZEBACH BSH GmbH, Bad Hersfeld (DE)

(21) Appl. No.: 18/017,230

(22) PCT Filed: Jul. 23, 2021
(86) PCT No.: PCT/EP2021/025283

§ 371 Date: Jan. 20, 2023

(30) Foreign Application Priority Data
Jul. 23, 2020 (DE) 10 2020 004 455.7

(51) Int. Cl. F26B 25/00; F26B 15/12; F26B 3/04

(52) U.S. Cl. CPC F26B 25/008; F26B 15/122; F26B 3/04; F26B 2210/14

(57) ABSTRACT

A dryer for drying veneers including a plurality of sections in which drying means for drying the veneers are present, wherein at least one of the sections there is a means for generating a negative pressure in the respective section.

The invention relates to a dryer for drying veneer panels according to the generic concept of claim 1.

The dryer according to the invention is provided in particular for drying veneer panels; however, the dryer according to the invention can also be used for drying any panels such as, for example, hardboard, plywood boards or wallboard and the like. In the following, the term “veneers” is always used for simplification; however, all other above-mentioned boards can likewise be dried by means of the veneer dryer instead of veneers.

Before the veneers are fed into the veneer dryer, they are first conveyed as a stack to a drying line by means of forklifts after peeling. At a loading device of the veneer dryer, the veneers are separated, placed on transport rollers and divided into different tiers, for example, with the aid of a swiveling device. The individual veneers are then transported into and through the dryer by rollers driven by chains. A screening belt can also be used instead of rollers.

The dryer is divided along its length into sections or zones. Each of the sections has its own heating system—usually a thermal oil or steam heated register—as well as a circulating air fan. By means of nozzle boxes, heated circulating air for drying the veneers is distributed over the individual tiers as well as over the width of the transport rollers and, after passing through the nozzles, flows out of the box onto the veneers, thus achieving impingement drying of the veneers. The veneers dried in this way leave the dryer at the dryer outlet.

Such a veneer dryer is known, for example, from DE 34 05 754 A1 or WO 2005/047793 A1.

The necessary fresh air enters the dryer via a dryer inlet and outlet; for this purpose, the dryer has openings in its end walls for the inlet and outlet of the veneers and the transport means. Some dryers have additional fresh air connections on the side. There are also dryers which have so-called “sealing fields” at the outlet and inlet. These are partitioned areas where vapors that occasionally escape can be extracted with the aid of a fan or several fans.

According to US 2016/0061521 A1, a control is to be provided to maintain the pressure within an outlet-side cooling section of a veneer dryer at a level greater than the pressure in the upstream drying chamber. By operating the cooling section at a slightly higher pressure, exhaust gases are to be prevented from escaping from the drying chamber into the cooling section, and for this purpose an automatic control is used to maintain the required pressure difference between the cooling section and the drying chamber pressure.

The dryer known from GB 340 510 A is not equipped with nozzle boxes, but has a single chamber extending along the entire length of the drying device of the dryer, in which there is a longitudinal air flow. Here it is provided that at the outlet end there is a positive static pressure inside the dryer with respect to the atmospheric pressure, while at the inlet end of the dryer there is a negative static pressure. Thus, at the outlet end, as a result of the overpressure, there is a risk of vapors and wood ingredients escaping from the dryer.

Since in a dryer for drying veneers not only the water contained in the veneers evaporates, but also wood constituents are released and accumulated in the drying air, especially in the rear part of the dryer, the problem arises that these constituents also condense again when their respective dew point is undershot.

Since cold air is drawn in at the inlet and outlet of the dryer, these areas are particularly affected. However, leaks occurring during prolonged operation (shaft seal of the conveyor belt for transporting the veneers inside the dryer, fan, door seals, cracks in welds) also lead to condensation due to contact with colder outside air. Condensation is detrimental for several reasons.

Depending on the type of wood, organic acids may be present in the condensate. In areas of the dryer where there is excess pressure, these can penetrate the insulation through leaks in the inner skin, where they can damage the metal outer skin of the dryer and the support frame through condensation and corrosion. The latter can corrode to such an extent through continuous exposure to such acidic and resinous vapors and fumes that the dryer even has to be shut down.

In addition, the condensed substances form flammable coatings on the walls of the dryer or on parts in the interior, which can catch fire. This is a well-known problem, especially at the dryer outlet, where it frequently leads to fires. However, the cooling panels and the chimneys there are also affected if vapors from the dryer reach them and condense there.

For this reason, the deposits must also be removed during maintenance shutdowns. This involves a great deal of work and at the same time generates a lot of dirt. The work is also physically demanding. To protect their health, the workers must wear a mouth guard and full-body coveralls.

Vapors also escape via the shaft seal of the conveyor belt or a fan and cause contamination there. When the dryer is shut down, the wood ingredients in the seal cool down, harden there, and cause it to stick. It may then no longer be possible to start the fan, which is also a disadvantage.

Another disadvantage is that the wood ingredients also enter the environment of the dryer through leaks and are inhaled by the people working there. This is a matter of concern because the ingredients are composed of hundreds of different chemical substances, the hazard potential of which is usually not even recorded.

Constructive solutions have become known which seek to limit the effects of the above-mentioned circumstances, even if the causes themselves remain untouched.

For example, one dryer manufacturer makes the outer skin of its dryers of stainless steel; apparently this is intended to mitigate the corrosion caused by condensing wood constituents. However, the use of stainless steel results in considerable additional costs; moreover, this measure only affects the outer skin of the dryer.

Another solution is to limit corrosion by means of openings in the outer skin of the dryer. This is expected to allow vapors to escape from the dryer even without condensation. However, it has been shown that if the inner skin is found to be leaking, damage also occurs to the surrounding dryer components in the vicinity of the leak. Stainless steel transport rollers used at the inlet and outlet of the dryer for similar reasons are also said to serve to contain corrosion in some dryers.

What all these solutions have in common is that, although they can alleviate the effects of the disadvantages described, they do not in themselves eliminate the disadvantages.

It is therefore the object of the present invention to create a dryer which does not have the disadvantages of the prior art described above.

The object is resolved as indicated in patent claim 1.

According to the invention, it is provided that in at least one of the sections there is a means for generating a negative pressure in the respective section.

Advantageous further embodiments of the invention are apparent from the subclaims, from the description and from the drawings, in particular in conjunction with the associated description.

According to the invention, the dryer is operated completely under negative pressure, except for sealing sections preferably located at the inlet and outlet, which are generated by at least one exhaust fan per zone. Due to the negative pressure then acting everywhere, no more dryer air can escape to the outside and cause the problems described. Instead, the dryer air is extracted from the dryer for each zone and preferably fed to a filter system before the air is discharged to the outside. This ensures that the dryer air cannot enter the machine room in which the dryer is installed; impurities such as resins and wood dust contained in the dryer air are removed from the dryer so that they cannot clog nozzles there, for example nozzles of the nozzle boxes, or other openings, or foul baffle plates attached to the dryer walls.

In the sections of the drying chamber, the negative pressure is then, for example, about −500 to −800 Pa, whereas in prior art veneer dryers values of about −50 to 0 Pa are usual for the sections of the drying chamber, and in places even positive pressures of 200 to 800 Pa are possible; at these points, drying gases can escape from the dryer in the case of leaks in prior art dryers and lead to the problems described above.

This means that, according to the invention, all areas of the dryer are operated in negative pressure. To avoid unwanted condensation, the dryer is provided with a special heated sealing chamber as a sealing section, at least at the outlet. However, a sealing section can also be provided at the inlet. According to the invention, the negative pressure can preferably be set individually for each section and determined by the suction power of the respective fan.

Preferably, however, a pressure gradient between the individual sections of the dryer is avoided according to the invention, with at most the inlet and outlet sections being operated at lower absolute pressures than the sections between them.

The sealing section, which is provided in particular at the outlet of the dryer but can additionally be used on the inlet side as a heated sealing chamber, is preferably not vented, as is usual in conventional dryers, but is supplied with hot air (100° C. to 200° C.) via a fan and a heating device.

Since the air supplied to the dryer is hot, condensation is effectively prevented there. This air also acts as sealing air between the dryer and the cooling sections.

Ideally, the sealing chamber is operated with a slight positive pressure or with a lower negative pressure to a cooling section downstream in the conveying direction. This prevents colder cooling air from lowering the air temperature in the chamber.

The use of such a sealing chamber as a sealing section at the dryer inlet is also advantageous if the occurrence of wood constituents is to be expected at this point due to the climate control system.

In order to be able to distribute the hot air optimally over the width and height of the dryer, nozzle boxes are preferably used for this purpose, as are generally used in dryers, as is known, for example, from WO 03/025484 A1.

In order to limit the consumption of hot air and thus improve thermal efficiency, it is helpful to arrange the heating element upstream of the circulating air fan, instead of downstream as is generally the case. The pressure in the drying chamber is then only −100 Pa to −300 Pa compared to the ambient pressure.

In order to minimize the consumption of hot air and thus improve thermal efficiency, the sealing of each section towards the exit of the dried veneers is constructed by the following measures: by installing a chain seal to minimize the air flow through the end face opening for the transport chains; by a brush seal, for example with a fabric insert between the first or last transport roller and the end walls of the dryer; and by closable openings, for example by adjustable flaps, or another closable opening in the end and/or side walls of the sections of the dryer, in order to be able to selectively adjust the climate in the dryer.

While negative pressure operation and its advantages are generally known in themselves (e.g., in curing ovens for mineral wool, or generally in dryers for toxic materials), this operation has not yet been used technically in the veneer industry, particularly because of the problems of with condensation. The improvements in the sealing system also make it possible to operate in the inherently advantageous negative pressure mode without the use of additional thermal energy.

The hot air applied sealing field and the chain seal are particularly advantageous elements of the present invention.

The invention is explained in more detail below in an embodiment example with reference to the drawings:

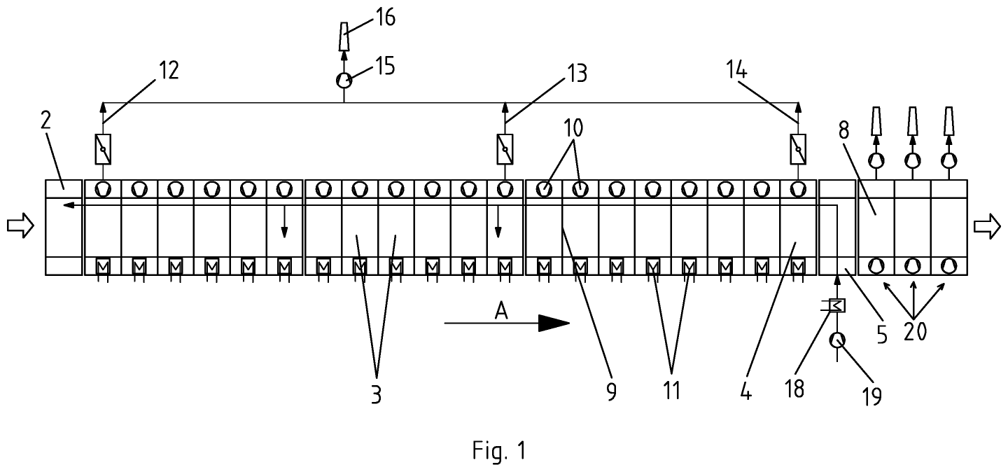

FIG. 1 shows a schematic top view of a veneer dryer according to the invention with a plurality of sections,

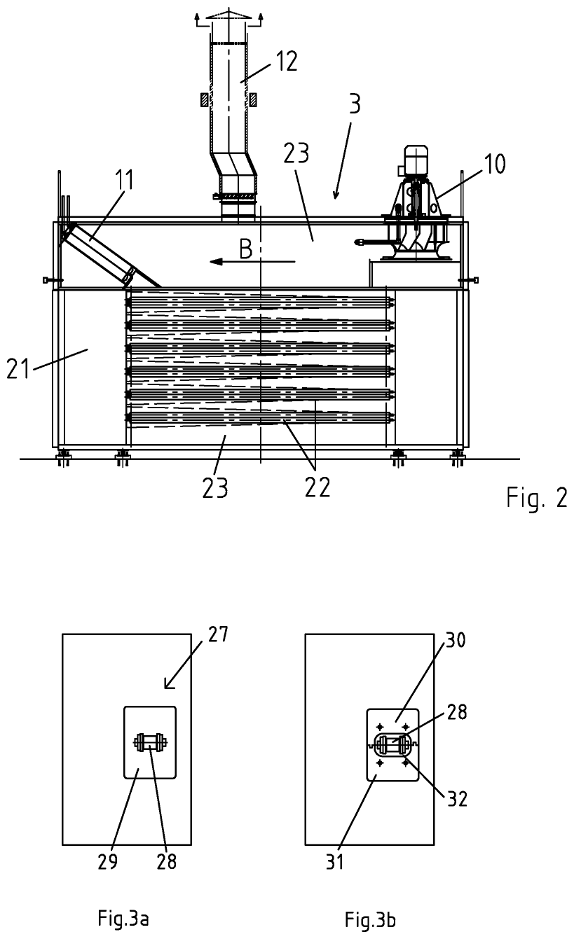

FIG. 2 shows a section with a plurality of nozzle boxes for drying the veneers,

FIG. 3a, b show seals for sealing transport chains on the end walls of the sections, and

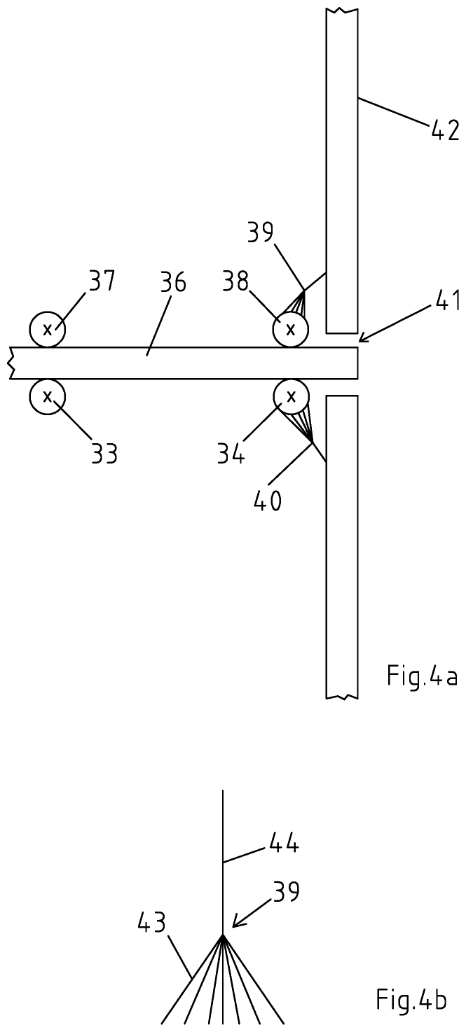

FIG. 4a, b show the transport of veneers in the area of the end walls of the sections and seals.

A veneer dryer 1 (FIG. 1) has, for example, a conveyor extending over the entire length of the drying system shown in FIG. 1, which comprises several belt, roller or chain conveyors 1 arranged one above the other. The direction of passage is illustrated by an arrow A. Along the conveyor device, starting in the direction of passage of the arrow A, a number of sections 3, for example up to about twenty sections, which are all operated at essentially the same temperature, are arranged one after the other downstream of an inlet zone 2; downstream of a section 4 follows a sealing zone 5, which is operated at a slight overpressure, for example 10 to 30 Pa above normal pressure or ambient air pressure, and a cooling zone 7, which consists of three sections 8. The number of sections 3, 4 is usually between five and twenty-five.

Each of the sections 3 to 8 has its own housing. In particular, the sections 3, 4 each have partitions 9 through which they are connected to each other and have, for example, 2 to 2.5 m in length built up.

In sections 3, 4, the pressure inside is lowered significantly with respect to the surrounding normal air pressure, as indicated above, in order to prevent vapors, solvent vapors and the like from evaporating and particles condensing therefrom from settling out of the veneers.

Each section 3, 4, 5 is provided with or is in communication with a means for generating dry air. Sections 3, 4 each have a recirculating air fan 10 (FIGS. 1, 2) for generating a flow of drying air within the respective section 3 or 4. A heating device 11 is provided in each section 3, 4, via which the air in the section 3, 4 is heated either directly (heating coil of an electric heater or burner) or indirectly (via steam, thermal oil or hot water).

Furthermore, each section 3, 4 is provided with a device for exhausting the heated air saturated with moisture and solvents from section 3, 4, the vapors. This device is either an exhaust fan associated with each individual section 3, 4 or a central exhaust and extraction system, by each section 3, 4 individually or at least a plurality of sections 3, 4 combined into groups, exhausts and extracts the vapors.

In accordance with the embodiment shown in FIG. 1, three groups of sections 3, 4 arranged one behind the other are combined, the vapors of which are each discharged together in groups via lines 12, 13 and 14 to a central exhaust air valve 15 and from this to a stack 16. Each of the lines 12 to 14 is equipped with a throttle valve 17 in order to be able to control or regulate the amount of extracted air.

The sealing field 5 is also connected to a heating device 18, through which warm air supplied via a supply air valve 19 is introduced into the sealing field 5 under slight positive pressure. Three cooling zones 20 are arranged downstream of the sealing field 5.

Alternatively, each section 3, 4 is equipped with its own exhaust fan or other means for extracting vapors, which is designed in a manner known to the skilled person so that these are extracted along the length of all sections in accordance with the desired drying profile.

In each of the sections 3, 4, air flows from a recirculation fan 10 (FIG. 2), the flow direction of which is indicated by an arrow B, to the heating device 11, where it is heated. From the heating device 11, the air is led into a pressure chamber 21. The pressure chamber 21 serves to distribute the air uniformly to the individual levels of a drying chamber 23 equipped with nozzle boxes 22. The air is thereby forced into the nozzle boxes 22, from which it is blown perpendicularly onto the veneers passing through the drying chamber 23 between the nozzle boxes 22 via perforated nozzles arranged on the upper and lower sides of the nozzle boxes 22, respectively. The veneers rest on support rollers and are conveyed perpendicular to the viewing plane of FIG. 2 by means of a transport device (not explained in detail here). The support rollers are arranged between and slightly above the nozzle boxes 22 so that the drying air flows between the support rollers onto the veneers.

To ensure optimum flow and introduction of the drying air from a ceiling box 24 into the pressure chamber 21 and from this via the nozzle boxes 22 along the veneers into a suction chamber 25, the width of the pressure chamber 21 is greater in relation to the width of the suction chamber 25.

By means of the exhaust stack, part of the drying air is extracted so that the air pressure inside each of the sections 3, 4 can be lowered by up to 300 Pa. The simultaneous extraction of the substances contained in the drying air prevents them from settling on the inner walls of sections 3, 4 or elsewhere. In this way, any corrosion is avoided. The exhaust air is preferably sucked out of the suction chamber of the first fan 10.

The drying air extracted by the fan 25 is preferably passed through a filter system (not shown here) in which corrosive constituents of the drying air are selectively separated out so that the cleaned drying air can be fed back into the system where required.

An adjustable flap 26 is arranged at the end side of those sections 3, 4 whose neighboring section is to have or can have a different negative pressure, in order to be able to adjust the air pressure, the temperature as well as the moisture content and/or further parameters inside the respective section 3, 4.

If the veneers are transported by rollers or conveyor belts driven by chains, these are also largely sealed in the area where the chains emerge from the end walls of those sections 3, 4 where pressure differences are to be expected, in order to maintain the negative pressure in the sections 3, 4 as far as possible.

In a guide area 27 (FIG. 3a) of a chain 28, the latter has a free cross section 29. At the exit of the chain 28 from the wall of the respective section 3, 4, sealing plates 30, 31 are provided above and below the chain 28, which are additionally equipped with elastic sealing lips or sealing lamellas 32 towards the chain 28.

For the transport of veneers 36, pairs of rollers 33, 37 and 34, 38 (FIG. 4a) are used, between which the veneers 36 are passed. According to the invention, in order to largely limit leakage of the respective one of the sections 3, 4 at the inlet and outlet of the veneers 36, respectively, and to contain the loss of negative pressure inside the respective one of the sections 3, 4, sealing devices 39, 40 are provided, which cooperate with the rollers 34 and 38 on the lower and upper sides of the veneers 36, respectively, in order to prevent air from entering the respective one of the sections 4 to 6 through the open slot 41 provided in the area of an end-side outer wall 42.

The sealing devices 39 comprise, for example, a plurality of bristles 43 formed, for example, from animal hair or from metal wire, or lamellae formed, for example, from rubber or plastic. The bristles 43 are bundled by a support 44, which is preferably attached to the inside of the outer wall 42.

The measures provided according to the invention to maintain a substantial negative pressure in sections 3, 4 can be realized in all types of veneer dryers, for example in the veneer dryer already mentioned at the beginning, disclosed in WO 03/025484 A1, or in the veneer dryer known from WO 2005/047793 A1, which discloses a loop-shaped guiding of the veneers between two conveyor belts.

1. A dryer for drying veneers, comprising a plurality of sections in which drying means for drying the veneers are present,
wherein in at least one of the sections there is a means for generating a negative pressure in the respective section.

2. The dryer according to claim 1,
wherein the means comprises at least one suction device or fan for sucking air out of the interior of the respective section.

3. The dryer according to claim 1,
wherein the at least one fan is arranged on the upper side of the respective section.

4. The dryer according to claim 2,
wherein the at least one fan is arranged in each case above a circulating air fan.

5. The dryer according to claim 1,
wherein means are provided for sealing the interior of the respective section.

6. The dryer according to claim 5,
wherein the means comprise seals on a chain for driving rollers in the region of an end-side outer wall of the respective section.

7. The dryer according to claim 5,
wherein the means have sealing devices for sealing rollers in the region of the end-side outer wall.
